(19) United States
(12) Patent Application Publication
(10) Pub. No.: US 2006/0103609 A1
(43) Pub. Date: May 18, 2006

(54) Method for driving bistable organic light emitting device display

(75) Inventors: Kuan-Jui Ho, Tainan City (TW); Ching-Jan Chao, Hsinchu County (TW); Chun-Te Lu, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/280,343

(22) Filed: Nov. 17, 2005

(30) Foreign Application Priority Data
Nov. 18, 2004 (TW) 093135371

(51) Int. Cl. G09G 3/30

(52) U.S. Cl. 345/76

(57) ABSTRACT

Methods for driving a display consisting of organic bistable light-emitting devices (OBLEDs), each corresponding to one pixel in the display. An exemplary method comprises respectively writing a signal during a sub-frame, into each selected OBLED, applying a certain voltage to all the OBLEDs such that the brightness of each OBLED is determined by the signal stored therein, nd erasing the signals stored in all the OBLEDs.

### BACKGROUND OF THE INVENTION

1. Field of the Invention

The invention relates to organic light emitting displays and, in particular, to driving bistable organic light emitting device displays.

2. Description of the Related Art

Unlike passive display panels, image information written into pixels in an active display panel is retained in memory. In passive addressing method, scan lines are turned on sequentially. When each scan line is turned on, light emitting devices on the scan line emit light according to current conducted thereto. Thus, each device is driven by short pulses, averaging visible brightness thereof. The high pulse required to drive each device requires higher operating voltage and current, degrading lifetime and emission efficiency of the device significantly. The passive addressing method, however, is simple and easy to modify and fabricate, making it suitable for small panel applications. To the contrary, each pixel in an active organic light emitting device display panel operates independently. Since a light emitting device is current-driven, each pixel needs at least two transistors and one capacitor to function. Thus, a pixel circuit mainly comprises a switching transistor, a driving transistor and a storage capacitor. The switching transistor switches and addresses to store image signals in the storage capacitor. The driving transistor converts the signal stored in the storage capacitor to a current. The current flows through the organic light emitting device and light is thereby generated. A gray level of each pixel can be controlled by adjusting the current. The active organic light emitting display offers low driving voltage, and low power consumption, compatibility with panels of any size, long lifetime and high brightness. Fabrication of the organic light emitting device display, however, requires low temperature poly-silicon (LTPS) or amorphous silicon thin film transistor (α-Si TFT) technology. The technology is provided with higher entry barrier and higher fabrication cost. Thus, if a passive display panel is provided with memory capability, it can overwhelm conventional active and passive display panels.

An organic bistable device was proposed in Applied Physics Letters, Vol. 80, No. 3, P. 362 by Yang in January, 2002. The organic bistable device is provided with bistable memory states. The device characteristics are shown in FIG. 1. The horizontal axis shows operating voltage and the vertical axis current. In an initial state, the voltage is 0V. The current follows and increases with voltage. When the voltage surpasses a threshold, the current increases abruptly, shown in the vertical section in curve I and maintains a high state. Herein, the threshold voltage refers to voltage generating the sudden rise in the current. If the threshold voltage is not surpassed, the conducted current follows the curve at the bottom. Once the threshold voltage is surpassed, the conducted current maintains a high state, shown as curve II, even when operating voltage is reduced. The organic bistable device recovers the initial state, curve I, only when negative voltage is provided. Herein, bistable memory characteristics are the conducted current of the organic bistable device is determined according to previously received voltage.

The organic bistable device, provided with memory capability, enables a previous operating state to be recorded, written to the organic bistable device, including whether operating voltage thereof exceeded a threshold voltage. When an organic bistable device is to be read, an operating voltage lower than the threshold voltage is applied thereto. Low current indicates that operating voltage of the organic bistable device never exceeded the threshold voltage, and high current that the operating voltage exceeded the threshold voltage. Conductive and non-conductive states respectively correspond to binary sates “1” and “0” of a digital logic circuit.

An organic light emitting diode (OLED) is bi-terminal device. When an operating voltage thereof is high enough, current therethrough drives the OLED to emit light. To accomplish high contrast image display, contrast ratio of the operating current needs to be large. Such requirements match the requirements of an organic bistable device. Conductive and non-conductive states of the OBD can respectively be utilized to result in emission and non-emission states of the OLED. The OBD and the OLED are both bi-terminal and can be connected in series to form a bi-terminal device, referred to as organic bistable light emitting diode (OBLED). As disclosed in patent application US 2002/01900664 A1, related to electrical characteristics of an OBD, an OBLED retains memory of a bistable state of the OBD. As shown by curve I in FIG. 2, the current increases significantly when the operating voltage exceeds 6V. When the operating voltage decreases, the current follows the curve II and back to the origin.

### BRIEF SUMMARY OF INVENTION

Driving methods according to the invention are related to writing signals to pixels of an OBLED array such that pixels emit light and provide image quality equivalent to an active-driven type display panel.

An embodiment of a driving method of an organic bistable light emitting device (OBLED) display comprises respectively writing a signal during a sub-frame, into each selected OBLED, applying a pre-determined voltage to all the OBLEDs such that the brightness of each OBLED device is determined by the signal stored therein, and erasing the signals stored in all the OBLEDs.

Another embodiment of a driving method of an organic bistable light emitting device (OBLED) display comprises writing signals during a sub-frame, into every OBLED, erasing the signals stored in selected OBLEDs, and applying a pre-determined voltage to all the OBLEDs such that the brightness of each OBLED device is determined by the signal stored therein.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 shows electrical characteristics of an organic bistable device;

FIG. 2 shows electrical characteristics of an organic bistable light emitting device;

FIG. 3 is a flowchart illustrating a driving method of an organic bistable light emitting device display according to an embodiment of the invention;

FIGS. 4A˜4E are schematic diagrams of the driving method in FIG. 3;

FIG. 5 shows grey levels of the organic bistable light emitting device controlled by pulse width modulation;

FIG. 6 is a flowchart illustrating a driving method of an organic bistable light emitting device display according to another embodiment of the invention; and

FIGS. 7A˜7D are schematic diagrams of the driving method in FIG. 6.

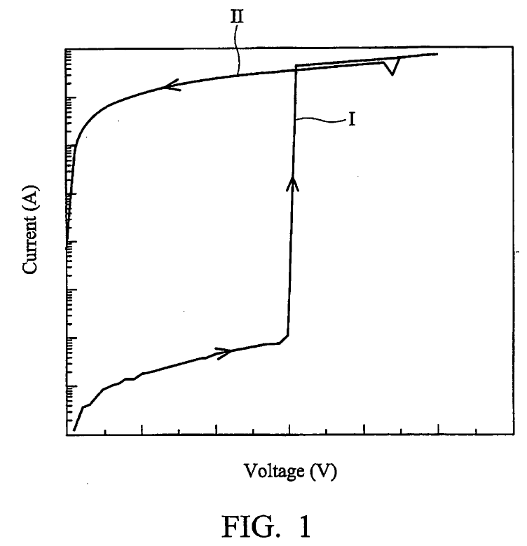

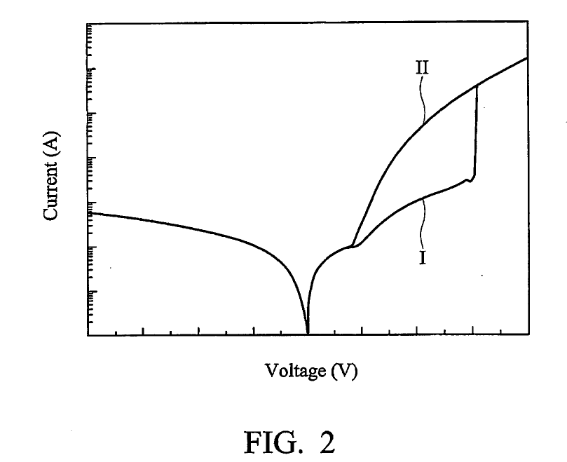

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

An organic bistable light emitting device (OBLED) display is a passive organic light emitting device (OLED) or polymer light emitting device (PLED) panel. A pixel is formed at each intersection of a row and a column. An organic bistable device (OBD) or other device similar thereto can be attached to the OLED or PLED and the OBLED is thus formed in each pixel.

For an organic bistable light emitting device panel, every row line and column line are respectively coupled to a row driver and a column driver. Each driver provides at least three states. The three states refer to three different voltages and states, such as 0V, 5V, and HiZ (high output impedance in a digital circuit, sometimes referred to as high impedance or tri-state).

A row line is coupled to an anode of an organic bistable light emitting device (OBLED) and a column line to a cathode thereof. Alternatively, the row line can be coupled to the cathode of the OBLED and the column line to the anode thereof. The two cases only differ in that the row lines and column lines need to be interchanged such that a normal function can be provided.

For the OBLED in the disclosure, three operating modes, i.e., three operating voltages, are provided. The voltage referred to is a voltage difference between the anode and the cathode of the OBLED. Since voltages of the anode and the cathode of the OBLED are respectively provided by the row driver and the column driver, voltages between output voltages of the row and column drivers result in three modes. In a write mode, the operating voltage is Vw, exceeding the threshold voltage Vth of the OBLED. In a read mode, the operating voltage is Vr, which ranges between 0 and the threshold voltage Vth. In an erase mode, the operating voltage is Ve, a negative value.

The operating voltages can be provided by commonly used digital logic integrated circuits. Output voltages of a row driver are respectively Vr_HIGH, Vr_LOW and HiZ. Output voltages of a column driver are respectively Vc_HIGH and Vc_LOW. The output voltages of the row an column drivers need to meet the requirements: Vr_HIGH>Vr_LOW>0; Vc_HIGH>Vc_LOW>0; Vth>Vr_HIGH-Vc_HIGH>0; Vr_HIGH-Vc_LOW>Vth; and Vr_LOW-Vc_HIGH<voltage required to erase the OBD<0.

An exemplary design is provided as follows. The threshold voltage Vth and erase voltage Ve of the OBLED are respectively 6V and −7V. Accordingly, the voltages Vw and Vr can respectively be set as 7V and 5V. A digital integrated circuit with 7V and 5V output voltages is coupled to the column driver. As a result, the column driver provides outputs signals of 7V, 5V and HiZ.

A digital integrated circuit with an output voltage of 12V is coupled to the row driver. The row driver thereby provides output signals of 12V, 0V and HiZ. The row driver does not require another power supply system according to proper IC design and a multiplexer utilized to select an appropriate output voltage. The exemplary design reveals that standard digital integrated circuits can be used to implement the OBLED display such that application specific integrated circuit (ASIC) is not required.

Combinations of the voltages in the exemplary design provide different bias voltages to the OBLED. Vw is a voltage of 7V resulting from the difference between 12V and 5V (Vw=12V−5V). Since Vw exceeds the threshold voltage Vth, the OBLED is biased at a state corresponding to characteristic curve II. Vr is a voltage of 5V resulting form the difference between 12V and 7V (Vr=12V−7V). The bias voltage Vr can only make the OBLED emit but cannot change the operating state of the OBLED. The voltage between 0V and 5V is undefined, which does not exist in a driving sequence of the OBLED. Ve is a voltage of −7V resulting form the difference between 0V and 7V (Ve=0V−7V). The voltage Ve is sufficient to change the characteristic of OBLED from the characteristic curve II to I. As long as either the row driver or the column driver outputs HiZ, there is no current through the OBLED. As a result, the operating state of the OBLED does not change and the OBLED does not emit light.

When the driving sources are provided, the OBLED display is controlled following the driving sequence, the operating sequence of the row and column drivers.

To more clearly explain the invention, some terms are exchangeable. A pixel “does not emit light” means the OBLED stays at characteristic curve I which corresponds to a binary state of “0” or “LOW”. A pixel “emits light” means the operating state of the OBLED is changed to the characteristic curve II, which corresponds to a binary state of “1” or “HIGH”. A pixel “does not emit light” means the light emitted from the pixel is insignificant compared to the state of “emit light”.

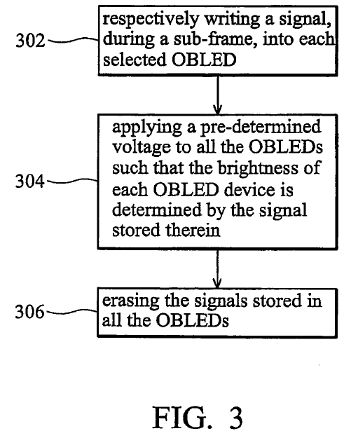

As shown in FIG. 3, an embodiment of a driving method of an organic bistable light emitting device (OBLED) display comprises respectively writing a signal during a sub-frame, into each selected OBLED (step 302), applying a pre-determined voltage to all the OBLEDs such that the brightness of each OBLED device is determined by the signal stored therein (step 304), and erasing the signals stored in all the OBLEDs (step 306).

In step 302, if signals are to be written to specific row lines of the display, the row lines are selected one after another. Each row line is selected at least once. The selected row line is programmed as Vr_HIGH. The pixels at the intersections of the selected row line and the column lines are ready to be programmed. If a pixel is to be programmed, the corresponding output voltage of the column driver is Vc_LOW. If the pixel is not to be programmed, the corresponding output voltage of the column driver is Vc_HIGH or HiZ. As a result, the OBLED in the pixel to be programmed is biased at a voltage equivalent to Vr_HIGH-Vc_LOW, Vw and higher than the threshold voltage. The OBLED in the pixel not to be programmed is biased at a voltage equivalent to Vr_HIGH-Vc_HIGH or Vr_HIGH-HiZ. If the OBLED is biased at a voltage of Vr_HIGH-Vc_HIGH, the bias voltage is lower than the threshold voltage and the OBLED is not programmed. If the OBLED is biased at a voltage of Vr_HIGH-HiZ, no current flows through the OBLED and the operating state thereof does not change. The row driver outputs HiZ to unselected row lines. Since the OBLED has memory capability, the signals written therein are saved. When signals are written to the pixels on the selected row lines, the driving sequence starts step 304.

In step 304, the row driver outputs Vr_HIGH to all row lines and the column driver outputs Vc_HIGH to all column lines. In other words, a bias voltage of Vr is applied to all the OBLEDs. The OBLEDs respectively emit light according to the written signals without changing the operating states thereof.

In step 306, the row driver outputs Vr-LOW to all row lines and the column driver outputs Vc_HIGH to all column lines. Since a negative voltage is applied to all OBLEDs in the pixels, the OBLEDs are erased and the operating states thereof changed to characteristic curve I.

Using an OBLED display of two rows and three columns as an example if peripheral row drivers and column drivers are coupled to the OBLED display, and an initial state of all the pixels is characteristic curve I. If any pixel has changed the operating state of characteristic curve II, the operating state is reset to characteristic curve I after an operating cycle. The operating cycle a sequence of steps 302, 304, and 306 and the cycle finishes with step 306. When the next cycle starts with the step 302.

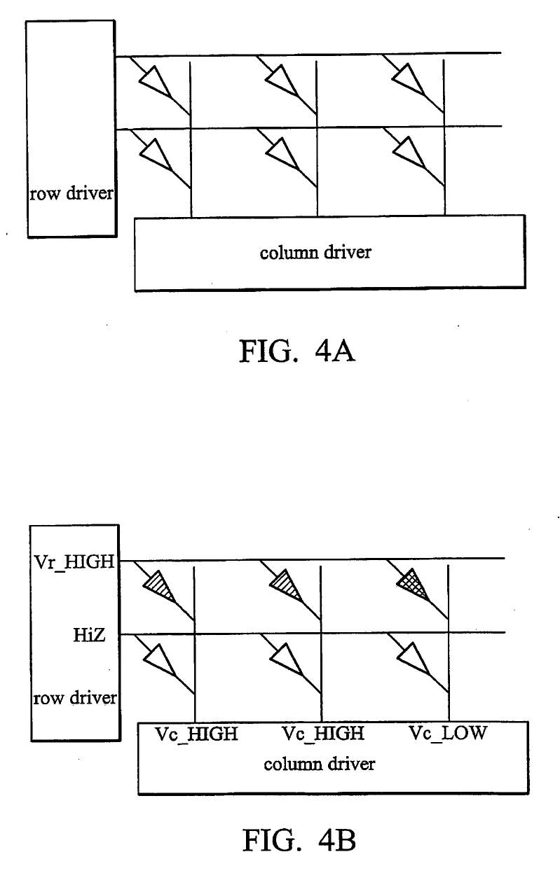

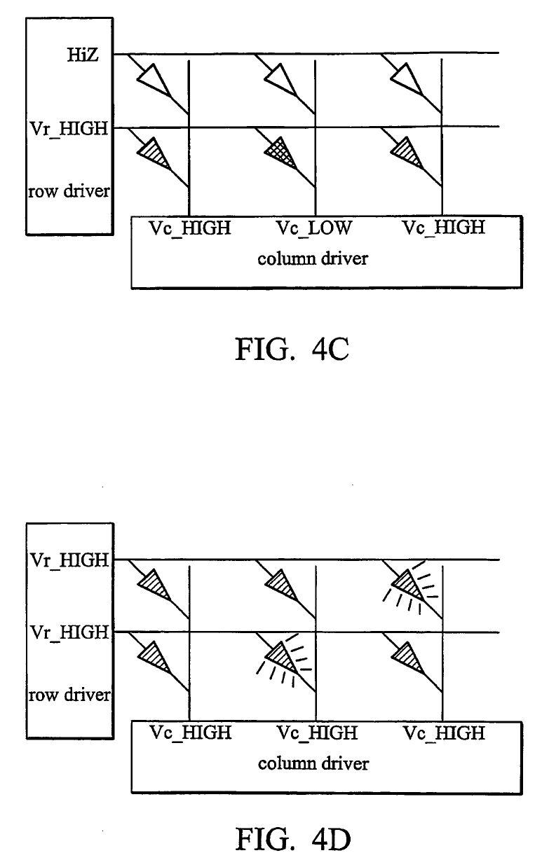

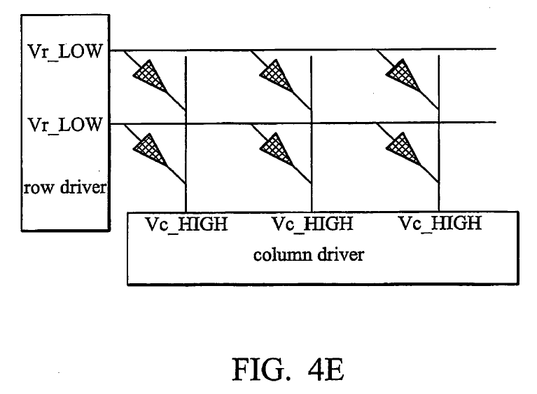

As shown in FIG. 4A, in the initial state, all pixels have the operating state of characteristic curve I. In step 302, as shown in FIG. 4B, the upper row is programmed as Vr_HIGH and the right column is programmed as Vc_LOW such that the operating state of the right pixel in the first row is changed to characteristic curve II. Thereafter, as shown in FIG. 4C, the lower row is programmed as Vr_HIGH and the right column is programmed as Vc_LOW such that the operating state of the right pixel in the first row is changed to characteristic curve II.

In step 304, as shown in FIG. 4D, a specified voltage is applied to all OBLEDs in the pixels. For example, a voltage of Vr_HIGH is applied to all the row lines and a voltage of Vc_HIGH to all the column lines. The pixels emit light according to the written signals therein. In other words, the pixels respectively operate according to the operating states of characteristic curve I or II.

In step 306, as shown in FIG. 4E, written signals in all pixels are erased. A voltage of Vr_LOW is applied to all the row lines and a voltage of Vc_HIGH to all the column lines. As a result, all pixels are reset to the operating state of the characteristic curve I.

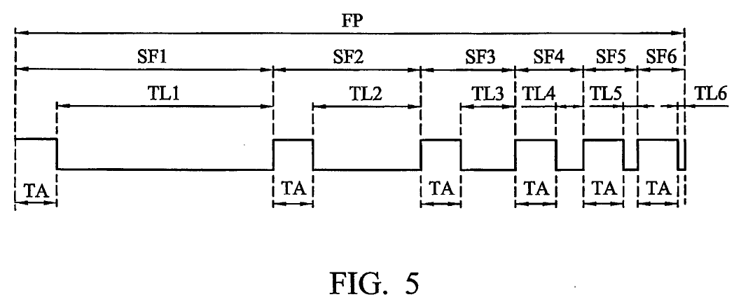

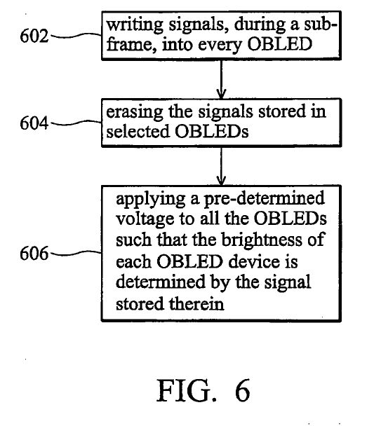

The disclosed method applies only to binary application (ON/OFF or emitting/non-emitting). If a multiple grey level display is required, pulse width modulation (PWM) can be utilized, as shown in FIG. 5. A main frame FP comprises a plurality of sub-frames SF1˜SF6. TA is the time for addressing and is less than a period of every sub-frame. A display time TL1 of the sub-frame SF1 is half of a total display time of the main frame FP. A display time TL2 of the sub-frame SF2 is one fourth of the total display time of the main frame FP, and so on. A display time TL5 of the sub-frame SF5 is one thirty-second of a total display time of the main frame FP. A display time TL6 of the sub-frame SF6 is one sixty-fourth of a total display time of the main frame FP. Total duration of the display times TL1˜T16 equals the total display time of the main frame FP. In other words, the display time of each sub-frame is a quadratic function of the total display time of the main frame. For visibility, different combinations of the display times TL1˜TL6 of the sub-frames SF1˜SF6 result in images with 64 grey levels. It is noted that in the invention, the display time of each sub-frame is not necessarily a quadratic function of the total display time of the main frame. Durations of the display times of the sub-frames can be the same. For example, 64 identical sub-frames can be utilized to display a 64 grey-level image. Alternatively, the display times of the sub-frames with different durations can also be utilized to display a 64 grey-level image.

As shown in FIG. 5, another embodiment of a driving method of an organic bistable light emitting device (OBLED) display comprises writing signals during a sub-frame, into every OBLED (step 602), erasing the signals stored in selected OBLEDs (step 604), and applying a predetermined voltage to all the OBLEDs such that the brightness of each OBLED device is determined by the signal stored therein (step 606).

In step 602, the row driver outputs Vr_HIGH to all row lines and the column driver outputs Vc_LOW to all column lines. In other words, a voltage of Vw is applied to all the OBLEDs and all the OBLEDs are changed to an operating state of the characteristic curve II.

In step 604, all pixels are originally driven to an emitting operating state. If some pixels are to be programmed as a non-emitting operating state, some of the row lines are selected according to where the non-emitting pixels are located. Each selected row line is selected at least once. The selected row lines are sequentially programmed as Vr_LOW and the unselected row lines are programmed as HiZ. If a pixel is to be programmed as a non-emitting operating state, a corresponding output voltage of the column driver is Vc_HIGH. If no change is required to the operating state thereof, the corresponding output voltage of the row driver is Vc_LOW or HiZ. As a result, the OBLED in the pixel to be programmed as a non-emitting operating state is biased at a voltage equivalent to Vr_LOW-Vc_HIGH, Ve and a negative value. The OBLED biased at such voltage is reset to the operating state of the characteristic curve I. The OBLED in the pixel not to be programmed is biased at voltage equivalent to Vr_LOW-HiZ. If the OBLED is biased at a voltage of Vr_HIGH-HiZ, no current flows through the OBLED and the operating state thereof does not change. When signals are written to the pixels on the selected row lines, the driving sequence starts next step 606.

In step 606, the row driver outputs Vr_HIGH to all the row lines and the column driver outputs Vc_HIGH to all the column lines. A voltage of Vr is applied to all the OBLEDs. The pixels emit light according to the written signals therein without changing operating states thereof.

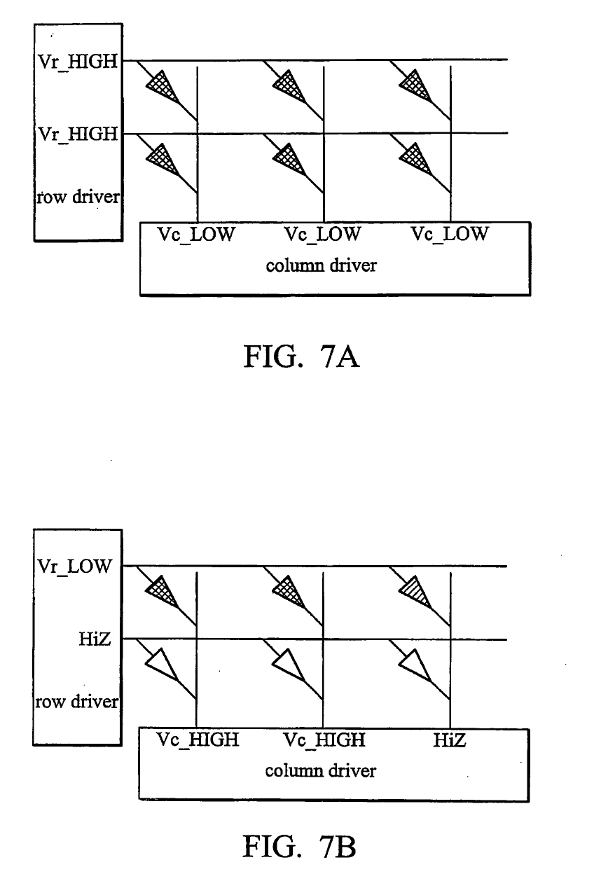

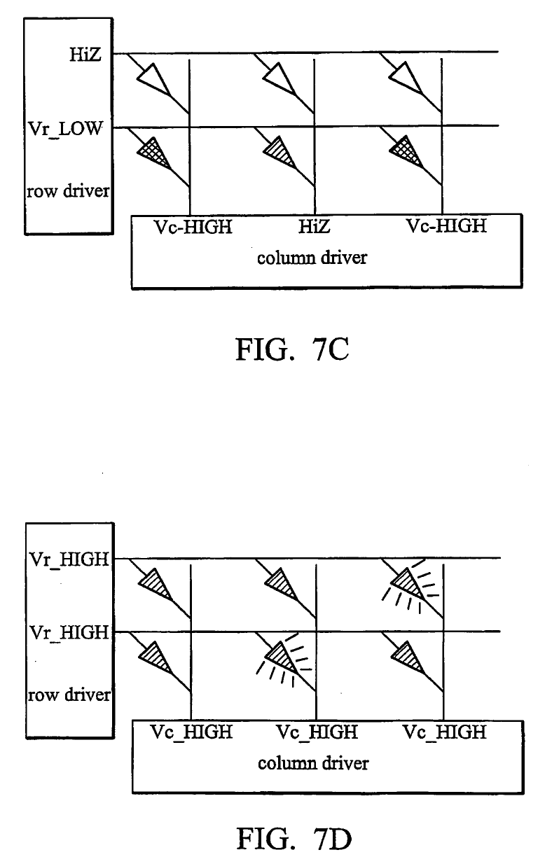

If an image as in the first embodiment is to be displayed in this embodiment, the driving sequence is illustrated as follows. As shown in FIG. 7A, in the step 602, all pixels are programmed as the operating state of the characteristic curve II.

In step 604, as shown in FIG. 7B, the first row line is programmed as Vr_LOW. Unlike the first embodiment, the left and middle pixels in the upper row are programmed as the operating state of characteristic curve I while the right pixel stays in the operating state of the characteristic curve II. As shown in FIG. 7V, the lower row is subsequently scanned and the left and right pixels programmed as the operating state of the characteristic curve I.

Thereafter, as shown in FIG. 7D, in step 606, a specified bias voltage is applied to all OBLEDs. For example, a voltage Vr_HIGH is applied to all row lines and a voltage Vc_HIGH to all column lines. the pixels respectively operate according to the operating states of characteristic curve I or II

The disclosed method applies only to binary application (ON/OFF or emitting/non-emitting). If a multiple grey level display is required, pulse width modulation (PWM) can be utilized. The details of the PWM method are described in the first embodiment.

The embodiments of the invention utilize a memory effect of an OBD to allow an OBLED to record and erase written signals. When row lines are not scanned, all pixels stays in a previous state and the image display does not change. Since only simple coatings are required to form OBDs and the coatings of the OBDs are similar to OLEDs, it is simple to integrate processes thereof. Actively-driven and passively-driven displays differ only in memory effect. A passive OLED display without memory effect and a plurality of OBDs with memory effect collectively form a passive OLED display with memory effect. Embodiments of the invention utilize coating to form an OBD in each pixel such that each pixel has memory effect. Embodiments of the driving method of the OBLED display write signals in to the OBLEDs in the pixels such that the pixels emit light and provide display image quality equivalent to an actively-driven display.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving method for an organic bistable light emitting device (OBLED) display, comprising, during a sub-frame:
writing a signal to each selected OBLED in a pixel array;
applying a specified voltage to all OBLEDs such that the brightness of each is determined by the signal stored therein; and
erasing the signals stored in all OBLEDs.

2. The driving method for an OBLED display as claimed in claim 1, wherein writing a signal into each selected OBLED in a pixel array comprises:
writing signals to the OBLEDs in the selected pixels in a first row line;
writing signals to the OBLEDs in the selected pixels in a second row line; and
so on;
wherein each row line is scanned at least once.

3. The driving method for an OBLED display as claimed in claim 1, wherein a plurality of isometric sub-frames collectively form a main frame and brightness of the main frame depends on a sum of brightness of the sub-frames.

4. The driving method for an OBLED display as claimed in claim 1, wherein a plurality of non-isometric sub-frames collectively form a main frame and brightness of the main frame depends on a sum of brightness of the sub-frames.

5. A driving method for an organic bistable light emitting device (OBLED) display, comprising, during a sub-frame:
writing signals to all OBLEDs in a pixel array;
erasing signals stored in selected OBLEDs in the pixel array; and
applying a specified voltage to all OBLEDs such that the brightness of each is determined by the signal stored therein.

6. The driving method for an OBLED display as claimed in claim 1, wherein erasing the signals stored in selected OBLEDs in a pixel array comprises:
erasing signals to the OBLEDs in the selected pixels in a first row line;
writing signals to the OBLEDs in the selected pixels in a second row line; and
so on;
wherein each row line is scanned at least once.

7. The driving method for an OBLED display as claimed in claim 1, wherein a plurality of isometric sub-frames collectively form a main frame and brightness of the main frame depends on a sum of brightness of the sub-frames.

8. The driving method for an OBLED display as claimed in claim 1, wherein a plurality of non-isometric sub-frames collectively form a main frame and brightness of the main frame depends on a sum of brightness of the sub-frames.
